(19) United States
(12) Patent Application Publication
(10) Pub. No.: US 2024/0280674 A1
(43) Pub. Date: Aug. 22, 2024

(54) PHOTODETECTOR CROSSTALK REDUCTION

(71) Applicant: Continental Autonomous Mobility US, LLC, Auburn Hills, MI (US)

(72) Inventors: Roger Frederick DuPont, Ulm (DE); Barton M. Goldstein, Santa Barbara, CA (US); Mihail Milkov, Moorpark, CA (US); Osman Musa, Santa Barbara, CA (US)

(73) Assignee: Continental Autonomous Mobility US, LLC, Auburn Hills, MI (US)

(21) Appl. No.: 18/111,205

(22) Filed: Feb. 17, 2023

(51) Int. Cl. G01S 7/487; G01S 7/4861

(52) U.S. Cl. CPC G01S 7/487; G01S 7/4861

(57) ABSTRACT

A system for photodetector crosstalk reduction during a light pulse acquisition window. The system includes a photodetector with a first detector terminal and a second detector terminal. The photodetector is configured to convert received light to an electrical signal. An isolation FET includes an isolation drain, an isolation source, and an isolation gate. The isolation drain is electrically coupled to the detector voltage node, and the isolation source is electrically coupled to the first detector terminal. A bias voltage electrically coupled to the isolation gate is selected such that the isolation FET operates in a saturation region.

### BACKGROUND

A solid-state light detection and ranging (LIDAR) system includes a photodetector, or an array of photodetectors, essentially fixed in place relative to a carrier, such as a vehicle. Light is emitted into the field of view of the photodetector and the photodetector detects light that is reflected by an object in the field of view. For example, a Flash LIDAR system may emit pulses of light, e.g., laser light, into essentially the entire field of view of the photodetector(s). The time of flight of reflected photons detected by the photodetector is used to determine the distance of the object that reflected the light.

As an example, the solid-state LIDAR system may be mounted on a vehicle to detect objects in the environment surrounding the vehicle and to detect distances of those objects for environmental mapping. The detection of reflected light can be used to generate a 3D environmental map of the surrounding environment. The output of the solid-state LIDAR system may be used, for example, to autonomously or semi-autonomously control operation of the vehicle, such as propulsion, braking, steering, etc. Specifically, the system may be a component of or in communication with an advanced driver-assistance system (ADAS) of the vehicle.

### BRIEF DESCRIPTION OF THE DRAWINGS

FIG. 1 shows an example LIDAR sensor assembly.

FIG. 2 shows a block diagram of an example circuit for detecting an emitted light pulse by a detector array.

FIG. 3 shows an implementation of a detector circuit for one pixel of a LIDAR sensor assembly.

FIG. 4 shows an example method for photodetector crosstalk reduction during a pulse acquisition window.

### DETAILED DESCRIPTION

The present description disclosed systems and methods for detecting and isolating a light pulse reflected from an object. The configurations described can help mitigate crosstalk in Flash LIDAR system. In particular, Flash LIDAR illuminates the whole scene at once and returns from the whole scene are read back in one acquisition window. This means that a strong return from retroflector sign on the one side of the scene, for example, could cause crosstalk noise on the other side of the scene. This can effectively blind the LIDAR camera by the strong returns of a highly reflective object or an object that is close to the camera. The crosstalk mitigation circuit can lower the severity of those cases by hampering an event on one pixel reaching other pixels in the array.

In one configuration, each photodetector of an array of photodetectors is electrically isolated from a common voltage supply by a field effect transistor (FET) biased to operate in the saturation region. By doing so, the circuit beneficially reduces undesirable crosstalk between photodetectors and, as a result, increases sensor reading accuracy. In addition, the FET also reduces the impedance of the isolated net. This enables photodiodes in the sensor array to draw more charge from the isolated net through the FET.

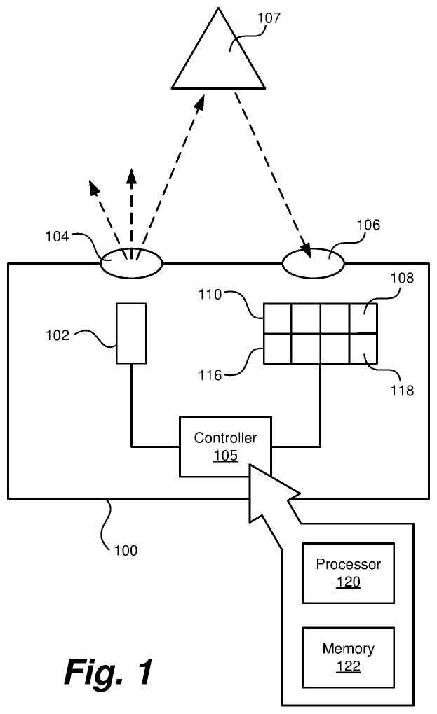

Throughout the description reference is made to FIGS. 1-4. When referring to the figures, like structures and elements shown throughout are indicated with like reference numerals.

In one exemplary configuration, an apparatus for detecting a light pulse reflected from an object is disclosed. The apparatus includes a ground voltage node and a detector voltage node. The apparatus also includes a photodetector configured to convert received light to an electrical signal. The photodetector includes a first detector terminal and a second detector terminal. An isolation FET is electrically coupled to the detector voltage node at an isolation drain terminal. The isolation FET is electrically coupled to the first detector terminal at an isolation source terminal. A bias voltage is electrically coupled to the isolation gate terminal of the isolation FET. The bias voltage is selected such that the isolation FET operates in a saturation region.

The apparatus may include a supply capacitor with a first supply capacitor terminal and a second supply capacitor terminal. The first supply capacitor terminal is electrically coupled to the first detector terminal and the second supply capacitor terminal electrically coupled to the ground voltage node.

The apparatus may include a gate capacitor with a first gate capacitor terminal and a second gate capacitor terminal. The first gate capacitor terminal is electrically coupled to the isolation gate terminal and the second gate capacitor terminal electrically coupled to the ground voltage node. In one configuration, an enable switch, with a first enable terminal and a second enable terminal, is electrically coupled to a bias voltage. Specifically, the first enable terminal is electrically coupled to a bias voltage node and the second enable terminal electrically coupled to the isolation gate terminal of the isolation FET.

The enable switch may be an enable FET with an enable gate. A controller electrically coupled to the enable gate can be configured to place the enable FET in a non-cutoff region prior to an acquisition period such that current passes from the bias voltage node to the gate capacitor. The controller may further be configured to place the enable FET in a cutoff region during the acquisition period such that the isolation gate terminal is electrically isolated from the bias voltage node. In one configuration, the bias voltage node is electrically coupled to the detector voltage node.

The apparatus may include a boost switch electrically coupled between the detector voltage node and the first detector terminal. A comparator, with a first comparator input, a second comparator input, and a comparator output, is electrically coupled to the first detector terminal at the first comparator input. The second comparator input is electrically coupled to a threshold voltage reference. The comparator output is configured to open the boost switch when a detector voltage at the first detector terminal is above the threshold voltage reference and to close the boost switch when the detector voltage is below the threshold voltage reference.

In one configuration, the boost switch is a boost FET. The boost FET includes a boost gate terminal electrically coupled to the comparator output such that the boost FET is placed in a cutoff region when the detector voltage is above the threshold voltage reference and the boost FET is placed in a non-cutoff region when the detector voltage is below the threshold voltage reference.

The apparatus may include a bias load with a first load terminal and a second load terminal. The first load terminal is electrically coupled to the first detector terminal and the second load terminal electrically coupled to the ground voltage node. In one configuration, the bias load is a constant current source.

Another exemplary configuration is a method for detecting a light pulse reflected from an object. The method may include steps of providing a detector voltage at a detector voltage node and biasing an isolation gate terminal of an isolation FET to a bias voltage such that the isolation FET operates in a saturation region. The isolation FET includes an isolation source terminal and an isolation drain terminal. The isolation drain terminal is electrically coupled to the supply voltage. The method includes charging a supply capacitor to a charge voltage via the detector voltage node and the isolation FET prior to an acquisition period. The supply capacitor is electrically coupled to a photodetector and the isolation terminal source at a detector node.

Another charging step of the method charges a gate capacitor to the bias voltage prior to the acquisition period. Charging the gate capacitor may include closing a bias switch electrically coupled between the bias voltage supply node and the gate capacitor.

An isolating step electrically isolates the gate capacitor from the bias voltage supply node during the acquisition period. Electrically isolating the gate capacitor may include opening the bias switch.

The method includes converting a light signal into an electrical signal by the photodetector during the acquisition period. A comparing step compares a detector voltage at the detector node to a threshold voltage reference. A closing step closes a boost switch when the detector voltage is below the threshold voltage reference, and an opening step opens the boost switch when the detector voltage is above the threshold voltage reference.

The boost switch is electrically coupled between the detector voltage node and the detector node such that the boost switch supplies current to the photodetector when the boost switch is closed. The boost switch may be a boost FET such that closing the boost switch includes placing the boost FET in a non-cutoff region and opening the boost switch includes placing the boost FET in a cutoff region.

Another exemplary configuration is a computer programmed to carry out the described method.

A further configuration of the disclosure below is an apparatus comprising a ground voltage node, a detector voltage node, and a photodetector. The photodetector includes a first detector terminal and a second detector terminal, and is configured to convert received light to an electrical signal. An isolation component is electrically coupled to the detector voltage node and the first detector terminal. A boost switch is electrically coupled between the detector voltage node and the first detector terminal.

A comparator includes a first comparator input, a second comparator input, and a comparator output. The first comparator input is electrically coupled to the first detector terminal. The second comparator input is electrically coupled to a threshold voltage reference. The comparator output is configured to open the boost switch when a detector voltage at the first detector terminal is above the threshold voltage reference and to close the boost switch when the detector voltage is below the threshold voltage reference.

The boost switch may be a boost FET with a boost gate terminal electrically coupled to the comparator output. In this configuration, the boost FET is placed in a cut-off region when the detector voltage is above the threshold voltage reference and the boost FET is placed in a saturation region when the detector voltage is below the threshold voltage reference.

FIG. 1 shows an example LIDAR sensor assembly 100 that includes a light source 102. The light source 102 may include a laser transmitter (not shown) configured to produce a pulsed laser light output. The laser transmitter may be a solid-state laser, monoblock laser, semiconductor laser, fiber laser, and/or an array of semiconductor lasers. The sensor assembly 100 may employ more than one individual laser. The pulsed laser light output may have a wavelength in the infrared range. It should be appreciated that other wavelengths of light may be produced.

The LIDAR sensor assembly 100 may also include a diffusion optic 104 to diffuse the pulsed laser light output produced by the light source 102. The diffused, pulsed laser light output may enable the LIDAR sensor assembly 100 to operate without moving, e.g., rotating, the light source 102.

The LIDAR sensor assembly 100 may also include a controller 105 in communication with the light source 102. The controller 105 may include a microprocessor and/or other circuitry capable of performing calculations, manipulating data, and/or executing instructions (i.e., running a program). The controller 105 in the exemplary configuration controls operation of the light source 102 to produce the pulsed laser light output.

The LIDAR sensor assembly 100 of the exemplary embodiment also includes a receiving optic 106, including a lens. Light produced by the light source 102 may reflect off one or more objects 107 and is received by the receiving optic 106. The receiving optic 106 can focus the received light into a focal plane. The focal plane is coincident with a plurality of light sensitive photodetectors 108. Each photodetector 108 is associated with a pixel of an image.

The photodetectors 108 may be arranged into one or more detector arrays 110. The photodetectors 108 of each detector array 110 may be arranged into a plurality of rows and columns to provide a generally rectangular shape. However, it should be appreciated that the detector array 110 may include any number of photodetectors 108 and may be arranged in other shapes and configurations.

Each photodetector 108 is configured to receive light produced by the light source 102 and reflected from at least one of the objects 107. Each photodetector 108 is also configured to convert received light to an electrical signal. The photodetectors 108 may be formed in a thin film of indium gallium arsenide (InGaAs) deposited epitaxially over an indium phosphide (InP) semiconducting substrate. However, the photodetectors 108 may be formed of other suitable materials, such as InSb, HgCdTe, silicon, SiGe, etc.

At least one readout integrated circuit (ROIC) 116 is bonded to the detector array 110. The ROIC 116 is formed with a silicon substrate but may be formed in gallium arsenide, indium phosphide, silicon germanium, silicon nitride, gallium nitride, or other wafer circuit technology. The ROIC 116 includes a plurality of unit cell electronic circuits (hereafter “unit cells” or “unit cell”) 118.

In one configuration, each unit cell 118 is associated with one of the photodetectors 108 and receives the electrical signal generated by the associated photodetector 108. Each unit cell 118 is configured to amplify the signal received from the associated photodetector 108 and sample the amplified output. The unit cell 118 may also be configured to detect the presence of an electrical pulse in the amplified output associated with a light pulse reflected from the object 107. Each unit cell 118 may be configured to perform functions other than those described above or herein. The unit cells 118 of the present configuration are arranged into a plurality of rows and columns. This second wafer circuit can be a silicon circuit bonded to the substrate of the detector array 110.

The controller 105 may include a computer processor 120 and memory 122. The computer processor 120 can be a microprocessor-based computing device, e.g., a generic computing device including an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer processor 120 may also be implemented as a combination of computing devices, e.g., a combination of a digital signal processor (DSP) and a microprocessor, a plurality of microprocessors, one or more microprocessors in conjunction with a DSP core, or any other such configuration.

The memory 122 can include media for storing instructions executable by the computer processor 120 as well as for electronically storing data and/or databases, and/or the computer processor 120 can include structures such as the foregoing by which programming is provided. Various types of memory technologies may be utilized in the memory 122, such as random access memory (RAM), read only memory (ROM), and Flash memory.

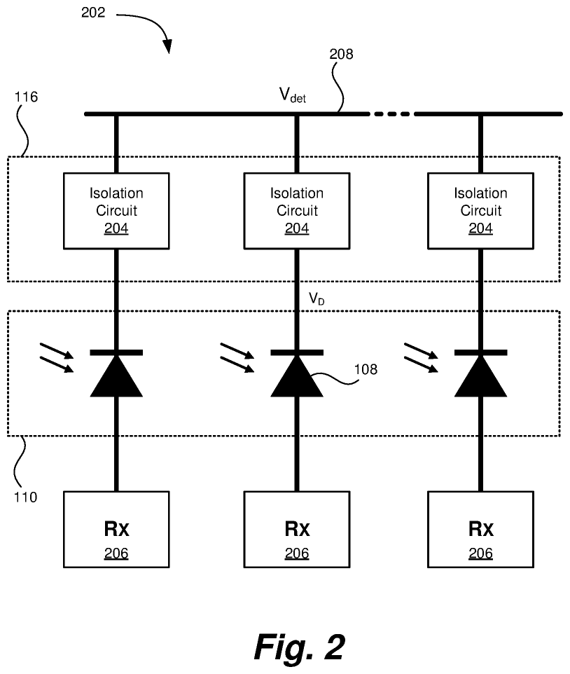

FIG. 2 shows a block diagram of an example circuit 202 for detecting an emitted light pulse by a detector array 110. Each detector array element includes a photodetector 108 electrically coupled to an isolation circuit 204 and a receiver circuit 206.

As discussed in detail below, the isolation circuit 204 electrically isolates the photodetectors 108 from a common voltage supply node referred to herein as a detector node 208 (V_{det}) and simultaneously reducing the impedance of the isolated photodiode node V_{D}. This beneficially reduces photo-current perturbation at the detector node 208 while mitigating waveform distortions due to strong current draws by the photodetectors 108.

The receiver circuit 206 is configured to drive a downstream circuit network which may be designed and used to determine the amplitude and delay of a laser pulse return.

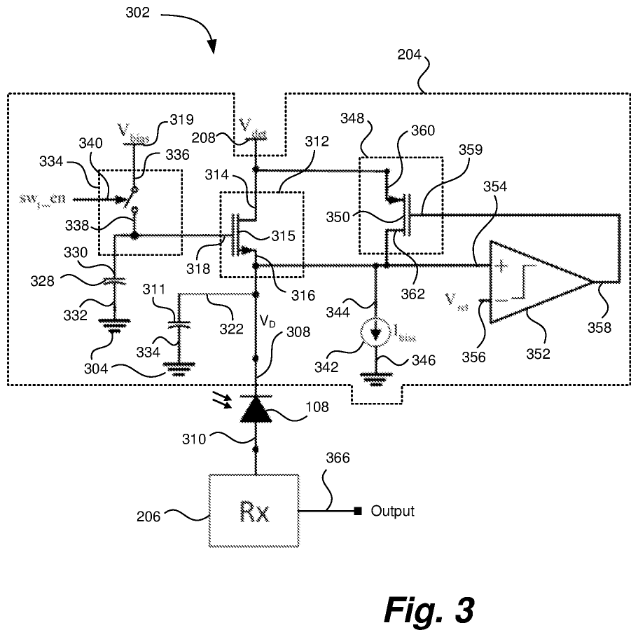

FIG. 3 shows an implementation of a detector circuit 302 for one pixel of a LIDAR sensor assembly 100. Portions of the detector circuit may be implemented on the detector array 110, while other portions of the circuit may be implemented on the ROIC 116.

The detector circuit 302 includes a ground voltage node 304 and a

detector voltage node 208. A photodetector 108 is configured to convert received light to an electrical signal. The photodetector 108 includes a first detector terminal 308 (cathode terminal) and a second detector terminal 310 (anode terminal). During an acquisition period, the electrical signals from the photodetectors 108 are sampled in order to determine the distance of objects 107 by measuring the time of the reflected light to return to the photodetector 108.

The detector circuit 302 includes an isolation component 312 electrically coupled to the detector voltage node 208 and the first detector terminal 308. The isolation component 312 is configured to electrically isolate the photodetectors 108 during an acquisition period by presenting a high impedance load between the detector voltage node 208 and the photodetectors 108, while reducing the impedance of the isolated photodiode node V_{D}.

In one configuration, the isolation component 312 is a n-channel field effect transistor (nFET) 315, identified herein as an isolation FET or an isolation nFET. The isolation nFET 315 may be, for example, a n-channel metal oxide semiconductor FET (nMOSFET), and can include an isolation drain 314, an isolation source 316, and an isolation gate 318. The isolation drain 314 is electrically coupled to the detector voltage node 208 and the isolation source electrically coupled to the first detector terminal 308. In one configuration, the isolation component 312 may include two or more isolation FETs 315 electrically cascaded in series circuit or parallel circuit.

During the acquisition period, a bias voltage at the isolation gate 318 places the isolation FET 315 in a saturation region. As used herein, the saturation region is a region of FET operation where current through the drain is controlled by the gate-source voltage (V_{GS}), while the drain-source voltage (V_{DS}) has little or no effect. At the saturation region the isolation FET 315 operates in a non-linear mode and has a high impedance between the isolation drain 314 and the detector voltage node 208. This characteristic helps reduce crosstalk between photodetectors 108. Furthermore, the isolation FET 315, operating in the saturation region, has a low impedance between the isolation source 316 and the isolated photodiode node V_{D}. This beneficially mitigates waveform distortions due to strong current draws by the photodetectors 108.

The isolation gate 318 may be directly coupled to a bias voltage node 319. The bias voltage is selected to place the isolation FET 315 in the saturation region. In one configuration, the bias voltage node 319 and the detector voltage node 208 are the same node. In one configuration, the isolation gate 318 is electrically coupled to a gate capacitor 328. The gate capacitor 328 includes a first gate capacitor terminal 330 and a second gate capacitor terminal 332. The first gate capacitor terminal 330 may be electrically coupled to the isolation gate 318 and the second gate capacitor terminal 332 may be electrically coupled to the ground voltage node 304. It is contemplated that the enable switch 334 may be an FET with an enable gate 340.

The first gate capacitor terminal 330 may be directly connected to the bias voltage node 319. In one configuration, the first gate capacitor terminal 330 is electrically connected to an enable switch 334. The enable switch 334 may include a first enable terminal 336 electrically coupled to the bias voltage node 319 and a second enable terminal 338 electrically coupled to the isolation gate 318. In one implementation, the enable switch 334 is configured to charge the gate capacitor 328 via the bias voltage node 319 prior to the acquisition period and to decouple the gate capacitor 328 from the bias voltage node 319 during the acquisition period. By doing so, perturbations at the bias voltage node 319 due to V_{GS} voltage fluctuations at the isolation FET 315 may be reduced and crosstalk between photodetectors 108 in the detector array 110 may be attenuated.

In one configuration, the controller 105 is electrically coupled to the enable gate 340. The controller 105 may be configured to place the enable FET in a non-cutoff region (i.e., linear region or saturation region) prior to the acquisition period such that current passes from the bias voltage node 319 to the gate capacitor 328. Once the gate capacitor 328 is sufficiently charged, the controller 105 may be further configured to place the enable FET in a cutoff region during the acquisition period such that the isolation gate 318 is electrically isolated from the bias voltage node 319.

The detector circuit 302 may include a supply capacitor 311 configured to bias the photodetector 108. The supply capacitor 311 includes a first supply capacitor terminal 322 electrically coupled to the first detector terminal 308 and a second supply capacitor terminal 324 electrically coupled to the ground voltage node 304. The supply capacitor 311 may help attenuate crosstalk current due to the finite input impedance of the isolation component 312.

In one configuration, the detector circuit 302 may include a bias load 342. The bias load 342 may include a first load terminal 344 and a second load terminal 346. The first load terminal 344 is electrically coupled to the first detector terminal 308 and the second load terminal 346 is electrically coupled to the ground voltage node 304. The bias load 342 may be, for example, a constant current source, such as a current mirror. In another configuration, the bias load 342 may be a resistor.

The detector circuit 302 may include a boost switch 348 electrically coupled between the detector voltage node 208 and the first detector terminal 308. The detector circuit 302 may also include a comparator 352. The comparator 352 includes a first comparator input 354 electrically coupled to the first detector terminal 308, and a second comparator input 356 electrically coupled to a threshold voltage reference V_{ref}. The comparator output 358 is configured to open the boost switch 348 when a detector voltage (V_{D}) at the first detector terminal 308 is above the threshold voltage reference V_{ref} and to close the boost switch 348 when the detector voltage is below the threshold voltage reference V_{ref}. The boost switch 348 and comparator 352 may be used with circuits where the isolation component 312 is not necessarily a FET. For example, the boost switch 348 and comparator 352 may be used with a resistor as an isolation component 312.

In one configuration, the boost switch 348 is a boost FET 350. The boost FET 350 includes a boost gate terminal 359 electrically coupled to the comparator output 358 such that the boost FET 350 is placed in a cutoff region when the detector voltage V_{D} is above the threshold voltage reference V_{ref} and the boost FET is placed in a non-cutoff region when the detector voltage V_{D} is below the threshold voltage reference V_{ref}. In one implementation, the boost FET 350 may be, for example, a p-channel MOSFET (pFET), with a boost source terminal 360 electrically coupled to the detector voltage node 208 and a boost drain terminal 362 electrically coupled to the detector voltage node 208.

The boost switch 348 may be used to provide a low-resistance path from detector voltage node 208 to the first detector terminal 308. For laser pulses large enough to generate a photo-current with peaks that cause the voltage at the first detector terminal 308 to dip below the voltage level V_{ref}, the comparator 352 will cause the boost switch 348 to turn on (close) and allow the photo-current to flow from the detector voltage node 208 to the first detector terminal 308 and keep the photodetector 108 reverse biased.

The second detector terminal 310 (anode terminal) of the photodetector 108 is coupled a receiver circuit 206 which could be any one of a number of topologies, including, for instance, a transimpedance amplifier (TIA). The receiver circuit 206 includes an output 366 for driving a downstream circuit network (not shown) which may be designed and used to determine the amplitude and delay of a laser pulse return. However, the receiver circuit 206 is not limited to LIDAR and could be applied to other wavelengths of incident light.

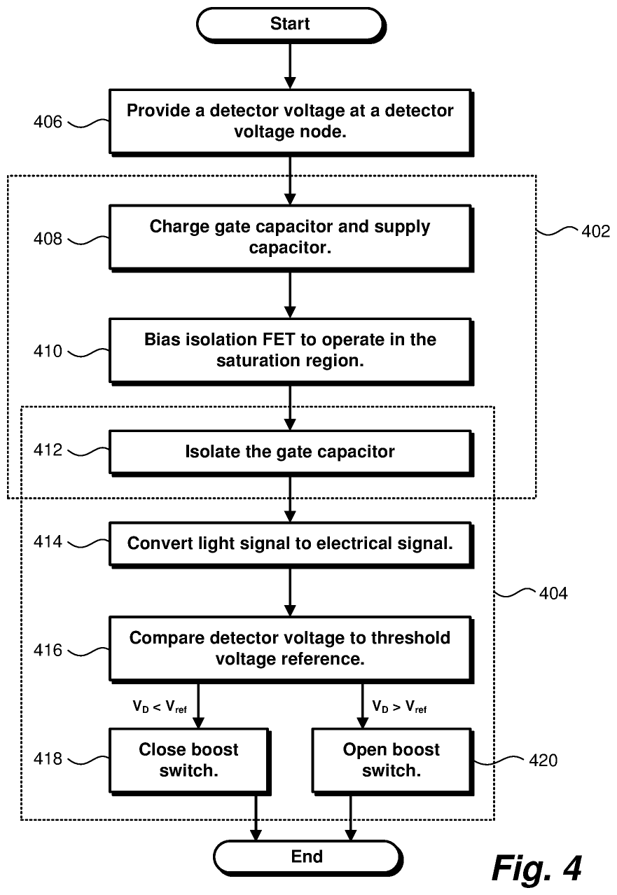

FIG. 4 shows an example method for photodetector crosstalk reduction during a pulse acquisition window. A controller 105 may include, for example, computer memory 122 storing instructions executable by a computer processor 120 to perform the method steps described below. In one configuration, some operations may be performed prior to an acquisition period 402, some operations may be performed during an acquisition period 404, and some operations may be performed during both periods. As discussed above, the acquisition period is a time period when electrical signals from the photodetectors 108 are sampled in order to determine the distance of objects 107 by measuring the time of the reflected light to return to the photodetectors 108.

The method includes a providing operation 406 where a detector voltage is provided at a detector voltage node 208. The detector voltage can be selected such that a photodetector 108 is reversed biased during the acquisition period 404. After providing operation 406, control passes to charging operation 408.

At charging operation 408, a gate capacitor 328 is charged to a bias voltage. The bias voltage is selected such that an isolation FET 315 electrically coupled to the photodetector 108 operates in a saturation region during the acquisition period 404. The bias voltage may be selected based on the desired reverse bias of the photodiode 108. For example, if the anode of the photodiode 108 is biased by the receiver circuit 206 at 1V, and the desired reverse bias of the photodiode is 1V, then the voltage of isolation FET's source terminal 316 needs to be 2V, and if Vgs of the isolation FET 315 is 0.5V when in saturation, then Vbias needs to be 2.5V. In one configuration, charging operation 408 may include closing a bias switch 335 electrically coupled between a bias voltage node 319 and the gate capacitor 328. In another configuration, the bias switch 335 is always closed.

Charging operation 408 may further include charging a supply capacitor 311. The supply capacitor 311 is electrically coupled to the photodetector 108 and the isolation source 316, and is charged to a charge voltage via the detector voltage node 208 and the isolation FET 315. After charging operation 408, control passes to biasing operation 410.

At biasing operation 410, an isolation gate 318 of an isolation FET 315 is biased to a bias voltage such that the isolation FET 315 operates in a saturation region. By operating the isolation FET 315 in the saturation region, the input impedance through the isolation drain 314 of the FET 315 is significant and a change in detector voltage V_{D} will produce little crosstalk current through isolation FET 315. After biasing operation 410, control passes to isolating operation 412.

Isolating operation 412 may occur prior to acquisition period 402 and continue during the acquisition period 404. At isolating operation 412, the gate capacitor 328 is electrically isolated from the bias voltage node 319. In one configuration, isolating operation 412 includes opening the enable switch 334 electrically coupled to the gate capacitor 328. For example, the enable switch 334 may be a nFET biased to the cutoff region such that essentially no current flow occurs between the bias voltage node 319 and the gate capacitor 328. After isolating operation 412, control passes to converting operation 414.

At converting operation 414, a photodetector 108 converts a light signal into an electrical signal. The photodetector 108 is configured to receive light produced by the light source 102 and reflected from at least one object 107 within the LIDAR's field of view. After converting operation 414, control passes to comparing operation 416.

At comparing operation 416, a threshold voltage reference V_{ref} is compared to a detector voltage V_{D} at the detector node. The detector node is an electrical node where the supply capacitor 311 is electrically coupled to the photodetector 108 and the isolation source 316. If, during the acquisition period 404, the detector voltage V_{D} is less than the threshold voltage reference V_{ref}, control passes to closing operation 418.

At closing operation 418, a boost switch 348 is closed. The boost switch 348 is electrically coupled between the detector voltage node 208 and the detector node V_{D} such that the boost switch 348 supplies current to the photodetector 108 when the boost switch 348 is closed. As discussed above, the boost switch 348 may be a pFET that is turned “on” at its boost gate terminal 359 by the comparator output 358. For example, closing operation 418 may include placing the boost FET 350 in a non-cutoff region.

If, during the acquisition period 404, the detector voltage V_{D} is greater than the threshold voltage reference V_{ref}, control passes to opening operation 420. At opening operation 420, the boost switch 348 is opened. Opening operation 420 may include placing the boost FET 350 in a cutoff region.

The descriptions of the various examples and implementations have been presented for purposes of illustration but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An apparatus comprising:
a ground voltage node;
a detector voltage node;
a photodetector including a first detector terminal and a second detector terminal, the photodetector configured to convert received light to an electrical signal;
an isolation n-channel field effect transistor (nFET) including an isolation drain, an isolation source, and an isolation gate, the isolation drain electrically coupled to the detector voltage node, the isolation source electrically coupled to the first detector terminal; and
a bias voltage electrically coupled to the isolation gate, the bias voltage selected such that the isolation nFET operates in a saturation region.

2. The apparatus of claim 1, further comprising a supply capacitor including a first supply capacitor terminal and a second supply capacitor terminal, the first supply capacitor terminal electrically coupled to the first detector terminal and the second supply capacitor terminal electrically coupled to the ground voltage node.

3. The apparatus of claim 1, further comprising a gate capacitor including a first gate capacitor terminal and a second gate capacitor terminal, the first gate capacitor terminal electrically coupled to the isolation gate and the second gate capacitor terminal electrically coupled to the ground voltage node.

4. The apparatus of claim 3, further comprising an enable switch including a first enable terminal and a second enable terminal, the first enable terminal electrically coupled to a bias voltage node and the second enable terminal electrically coupled to the isolation gate.

5. The apparatus of claim 4, wherein the enable switch is an enable FET, the enable FET including an enable gate.

6. The apparatus of claim 5, further comprising a controller electrically coupled to the enable gate, the controller configured to place the enable FET in a non-cutoff region prior to an acquisition period such that current passes from the bias voltage node to the gate capacitor.

7. The apparatus of claim 6, wherein the controller is configured to place the enable FET in a cutoff region during the acquisition period such that the isolation gate is electrically isolated from the bias voltage node.

8. The apparatus of claim 7, wherein the bias voltage node is electrically coupled to the detector voltage node.

9. The apparatus of claim 1, further comprising:
a boost switch electrically coupled between the detector voltage node and the first detector terminal; and
a comparator including a first comparator input, a second comparator input, and a comparator output, the first comparator input electrically coupled to the first detector terminal, the second comparator input electrically coupled to a threshold voltage reference, the comparator output configured to open the boost switch when a detector voltage at the first detector terminal is above the threshold voltage reference and to close the boost switch when the detector voltage is below the threshold voltage reference.

10. The apparatus of claim 9, wherein the boost switch is a boost FET, the boost FET including a boost gate terminal electrically coupled to the comparator output such that the boost FET is placed in a cutoff region when the detector voltage is above the threshold voltage reference and the boost FET is placed in a non-cutoff region when the detector voltage is below the threshold voltage reference.

11. The apparatus of claim 1, further comprising a bias load including a first load terminal and a second load terminal, the first load terminal electrically coupled to the first detector terminal and the second load terminal electrically coupled to the ground voltage node.

12. The apparatus of claim 11, wherein the bias load is a constant current source.

13. A method comprising:
providing a detector voltage at a detector voltage node;
biasing an isolation gate of an isolation n-channel field effect transistor (nFET) to a bias voltage such that the isolation nFET operates in a saturation region, the isolation nFET including an isolation source and an isolation drain, the isolation drain electrically coupled to the detector voltage;
charging a supply capacitor to a charge voltage via the detector voltage node and the isolation nFET prior to an acquisition period, the supply capacitor electrically coupled to a photodetector and the isolation source at a detector node; and
converting a light signal into an electrical signal by the photodetector during the acquisition period.

14. The method of claim 13, further comprising:
charging a gate capacitor to the bias voltage prior to the acquisition period; and
electrically isolating the gate capacitor from the bias voltage supply node during the acquisition period.

15. The method of claim 14, further comprising:
wherein charging the gate capacitor includes closing a bias switch electrically coupled between the bias voltage supply node and the gate capacitor; and
wherein electrically isolating the gate capacitor includes opening the bias switch.

16. The method of claim 13, further comprising:
comparing a detector voltage at the detector node to a threshold voltage reference;
closing a boost switch when the detector voltage is below the threshold voltage reference, the boost switch electrically coupled between the detector voltage node and the detector node such that the boost switch supplies current to the photodetector when the boost switch is closed; and
opening the boost switch when the detector voltage is above the threshold voltage reference.

17. The method of claim 16, further comprising:
wherein the boost switch is a boost FET;
wherein closing the boost switch includes placing the boost FET in a non-cutoff region; and
wherein opening the boost switch includes placing the boost FET in a cutoff region.

18. A computer programmed to carry out the method of claim 13.

19. An apparatus comprising:
a ground voltage node;
a detector voltage node;
a photodetector including a first detector terminal and a second detector terminal, the photodetector configured to convert received light to an electrical signal;
an isolation component electrically coupled to the detector voltage node and the first detector terminal;
a boost switch electrically coupled between the detector voltage node and the first detector terminal; and
a comparator including a first comparator input, a second comparator input, and a comparator output, the first comparator input electrically coupled to the first detector terminal, the second comparator input electrically coupled to a threshold voltage reference, the comparator output configured to open the boost switch when a detector voltage at the first detector terminal is above the threshold voltage reference and to close the boost switch when the detector voltage is below the threshold voltage reference.

20. The apparatus of claim 19, wherein the boost switch is a boost field effect transistor (FET), the boost FET including a boost gate terminal electrically coupled to the comparator output such that the boost FET is placed in a cut-off region when the detector voltage is above the threshold voltage reference and the boost FET is placed in a saturation region when the detector voltage is below the threshold voltage reference.
